(19) United States
(12) Patent Application Publication
(10) Pub. No.: US 2003/0167965 A1
(43) Pub. Date: Sep. 11, 2003

(54) Single cartridge magenta and color ink-jet set

(75) Inventor: Jen Fang Lin, Taipei (TW)

Correspondence Address: BACON & THOMAS, PLLC, 625 SLATERS LANE, FOURTH FLOOR, ALEXANDRIA, VA, 22314

(73) Assignee: Everlight USA, Inc., Pineville, NC (US)

(21) Appl. No.: 10/087,862

(22) Filed: Mar. 5, 2002

(51) Int. Cl. C09D 11/02

(52) U.S. Cl. 106/31.27; 106/31.58; 106/31.6; 106/31.86

(57) ABSTRACT

The present invention discloses a magenta ink for ink-jet printing, which primarily includes red 184 and a carrier. The present invention also discloses a color ink set for ink-jet printing, which primarily includes (a) a magenta ink including red 184 and a carrier, (b) a yellow ink and (c) a cyan ink. According to the color ink set of the present invention, an excellent image and broad color gamut can be easily generated. Furthermore, the present invention provides good outdoorfastness and lightfastness.

### BACKGROUND OF THE INVENTION

1. Field of the Invention

The present invention relates to a single cartridge magenta and color ink-jet ink set.

2. Description of the Prior Art

A conventional color ink-jet set as disclosed in U.S. Pat. No. 5,738,716 is primarily composed of phthalocyanine, red 122, yellow 74 and black 7. Unfortunately, when this ink-jet ink set is applied to ink-jet printing, common problems such as outdoor discoloration may occur.

For an ink-jet ink set containing organic pigment, the typical pigment requirement is around 30 wt. %. For a thermal bubble-type ink-jet printer, the weight of ink is around 0.1-10 wt. %, and preferably 0.1-5.0 wt. %. However, inorganic pigment usually has higher specific gravity than organic pigment, so that more weight percentage of inorganic pigment is needed in an ink set, for example, 75 wt. %.

In a typical water system, the carrier is about 70-98 wt. % based on the total weight, and preferably 90-98 wt. %. The carrier can be a solvent including water and polyhydric alcohol, in which a water-miscible solvent is contained and ranges from 5 to 60 wt. % based on the total carrier.

In order to control ink-jetting speed, distance between ink droplets, size of ink droplets and stability of ink flow, surfactants are applied to changing the surface tension and viscosity thereof. For a pigment-type ink jet printing system, the ink usually has a surface tension ranging from 20 to 60 dynes/cm, and preferably from 30 to 50 dynes/cm.

### SUMMARY OF THE INVENTION

One object of the present invention is to provide magenta ink for ink-jet printing, which generates a broad color gamut, excellent images, good outdoorfastness and lightfastness.

Another object of the present invention is to provide a color ink set for ink-jet printing, which generates a broad color gamut, excellent images, good outdoorfastness and lightfastness.

The pigment numbers mentioned hereinafter are in accordance with the Color Index, which is well known by those skilled in this art.

A well known pigment, red 184 has never been applied to ink-jet printing or been used as red ink. In the present invention, red 184 is used to produce a magenta ink with a carrier, wherein red 184 preferably has a concentration ranging between 0.1 wt. % and 5.0 wt. %.

The color ink-jet ink set of the present invention primarily includes (a) a magenta ink including red 184 and a carrier, (b) a yellow ink, and (c) a cyan ink, wherein red 184 in the magenta ink preferably has a concentration ranging between 0.1 wt. % and 5.0 wt. %.

The above yellow ink includes yellow pigment and a carrier, wherein the yellow pigment can be yellows 155, 150, 74, or mixtures thereof, with the yellow ink preferably ranging in concentration between 0.1 wt. % and 5.0 wt. %.

The cyan ink includes cyan pigment and a carrier, wherein the cyan pigment can be blue 15:3,blue 60, or mixtures thereof, with the cyan ink preferably ranging in concentration between 0.1 wt. % and 5.0 wt. %.

The color ink set of the present invention can further include (d) a black ink containing black 7 and a carrier, wherein black 7 in the black ink preferably has a concentration ranging between 0.1 wt. % and 5.0 wt. %.

The carrier aforementioned usually includes (i) at least a low vapor-pressure solvent, (ii) at least a surfactant, and (iii) water. Furthermore, the carrier optionally includes (iv) at least an additive.

A preferred color ink set of the present invention may be primarily composed of a magenta ink including red 184 and a carrier, a yellow ink including yellow 155 and a carrier, and a cyan ink including blue 15:3 and a carrier, whereby an excellent image can be generated.

Currently, ‘continuous jet’ and ‘drop-on-demand’ are two major ink-jet printing technologies, wherein ‘drop-on-demand’ can be further classified into two types, ‘bubble jet’ and ‘piezoelectric crystal’. The color ink set of the present invention is particularly suitable for ‘piezoelectric crystal’ type printing.

### BRIEF DESCRIPTION OF THE DRAWINGS

FIG. 1 shows the color gamut of the ink jet ink sets obtained from Example 1 and Comparative Example 1.

FIG. 2 shows the color gamut of the ink jet ink sets obtained from Example 3 and Comparative Example 3.

### DETAILED DESCRIPTION OF THE PREFERRED EMBODIMENTS

The present invention provides a color ink-jet set primarily composed of (a) a magenta ink including red 184 and a carrier, (b) a yellow ink and (c) a cyan ink. Optionally, the ink set of the present invention can include (d) a black ink.

The above yellow ink includes yellow pigment and a carrier, and is not restricted, provided that the yellow pigment is compatible with the red 184 to form an ink-jet set with a broad color gamut, and good outdoorfastness and lightfastness.

The above blue ink includes blue pigment and a carrier, and is not restricted, provided that the blue pigment is compatible with red 184 to form an ink-jet set with a broad color gamut, and good outdoorfastness and lightfastness.

The above carrier includes (i) at least a low vapor-pressure solvent, (ii) at least a surfactant, and (iii) water. Optionally, the carrier may include (iv) at least an additive.

The low vapor-pressure solvent in the carrier aforementioned can be glycols, such as ethylene glycol, diethylene glycol, triethylene glycol, tetraethylene glycol, propylene glycol, polyethylene glycol, polypropylene glycol and derivatives thereof, diols, such as propadiol, pentadiol, hexadiol and homologous diols, glycol esters, such as propylene glycol laurate, mono and di glycol ethers, such as cellosolve including ethylene glycil-monopropyl ester, diethylene glycol ethers, such as carbitol, diethylene glycol mono ether, monopropyl ether, monopentyl ether, propylene glycol ether, dipropenyl glycol ether, tripropenyl glycol ether, long chain alcohols, such as butyl alcohol, pentyl alcohol and homologous alcohols, and other solvents such as tetrahydrothenyl-1,1-dioxide, esters, ketones, lactones, such as Υ-butyrolactone, and lactams, such as 2-pyrrolyl ketone, N-pyrrolyl ketone N-pyrrolyl ketone and N-(2-ethylhydroxyl) pyrrolyl ketone, and glyceride, and derivatives thereof. For the present invention, the low vapor-pressure solvent is preferably mixture of lactams and glycols.

The low vapor-pressure solvent used in the present invention preferably has a concentration ranging between 0.001 wt. % and 20 wt. % based on the total weight.

The surfactant is usually added in the carrier at a concentration ranging between 0.05 wt. % and 10 wt. %. In general, the surfactant is a nonionic surfactant such as SURFYNOLS (Air Products & Chemicals, Inc.), and preferably has a concentration ranging between 0.1 wt. % and 1.0 wt. %.

In the present invention, the carrier can optionally include an additive, for example, microbial reagents such as NUOSEPT (Nudex, Inc., a division of Huls Americal), UCARCIDE (Union Carbide), VANCIDE (RT Vanderbilt Co.) and PROXEL XL2 (ICI Americas).

The microbial reagent additive can be added at an arbitrary concentration, preferably at 0.1-0.5 wt. %.

Some preferred embodiments are discussed to facilitate understanding of the present invention but not for limiting the scope thereof. The embodiments are described as the follows.

### PREPARATION EXAMPLE 1

Magenta Ink (R1)

2 parts of red 184, 5 parts of 2-pyrrolyl ketone, 5 parts of diethylene glycol, 25 parts of glycerol, 1 part of microbial reagent (PROXEL XL2), 1 part of surfactant (SURFYNOLS) and 61 parts of water are mixed at room temperature. The amounts in this example and examples hereinafter are measured by weight.

### PREPARATION EXAMPLE 2

Magenta Ink (R2)

2.5 parts of red 122, 5 parts of 2-pyrrolyl ketone, 5 parts of diethylene glycol, 12 parts of glycerol, 0.4 part of microbial reagent (PROXEL XL2), 0.4 part of surfactant (SURFYNOLS) and 75.1 parts of water are mixed at room temperature.

### PREPARATION EXAMPLE 3

Cyan Ink (B 1)

2 parts of blue 15:3, 5 parts of 2-pyrrolyl ketone, 5 parts of diethylene glycol, 20 parts of glycerol, 1 part of microbial reagent (PROXEL XL2), 1 part of surfactant (SURFYNOLS) and 66 parts of water are mixed at room temperature.

### PREPARATION EXAMPLE 4

Black Ink (BK)

2.7 parts of black 7, 5 parts of 2-pyrrolyl ketone, 5 parts of diethylene glycol, 20 parts of glycerol, 1 part of microbial reagent (PROXEL XL2), 1 part of surfactant (SURFYNOLS) and 65.3 parts of water are mixed at room temperature.

### PREPARATION EXAMPLE 5

Yellow Ink (Y1)

2.5 parts of yellow 155, 5parts of 2-pyrrolyl ketone, 5 parts of diethylene glycol, 20 parts of glycerol, 0.2 part of microbial reagent (PROXEL XL2), 1 part of surfactant (SURFYNOLS) and 66.3 parts of water are mixed at room temperature.

### PREPARATION EXAMPLE 6

Yellow Ink (Y2)

2.5 parts of pigment yellow 74, 5 parts of 2-pyrrolyl ketone, 5 parts of diethylene glycol, 12 parts of glycerol, 0.2 part of microbial reagent (PROXEL XL2), 1 part of surfactant (SURFYNOLS) and 74.3 parts of water are mixed at room temperature.

### PREPARATION EXAMPLE 7

Yellow Ink (Y3)

2.5 parts of pigment yellow 150, 5 parts of 2-pyrrolyl ketone, 5 parts of diethylene glycol, 12 parts of glycerol, 0.2 part of microbial reagent (PROXEL XL2), 1 part of surfactant (SURFYNOLS) and 74.3 parts of water are mixed at room temperature.

### EXAMPLE 1

Color Ink-Jet Ink Set of the Present Invention

The above inks R1, Y2, B1 and BK respectively made with red 184, yellow 155, blue 15:3 and black 7 are selected and transferred into a cartridge which is then positioned in an EPSON PRO7500 printer.

### EXAMPLE 2

Color Ink-Jet Ink Set of the Present Invention

The above inks R1, Y2, B1 and BK made with red 184, yellow 74, blue 15:3 and black 7 are selected and transferred into a cartridge which is then positioned in an EPSON PRO7500 printer.

### EXAMPLE 3

Color Ink-Jet Ink Set of the Present Invention

The above inks R1, Y3,B1 and BK respectively made with red 184, yellow 150,blue 15:3 and black 7 are selected and transferred into a cartridge which is then positioned in an EPSON PRO7500 printer.

### COMPARATIVE EXAMPLE 1

Conventional Color Ink-Jet Ink Set

The above inks R2, Y1, B1 and BK respectively made with red 122, yellow 155, blue 15:3 and black 7 are selected and transferred into a cartridge which is then positioned in an EPSON PRO7500 printer.

### COMPARATIVE EXAMPLE 2

Conventional Color Ink-Jet Ink Set

The above inks R2, Y2, B1 and BK respectively made with red 122, yellow 74, blue 15:3 and black 7 are selected and transferred into a cartridge which is then positioned in an EPSON PRO7500 printer.

### COMPARATIVE EXAMPLE 3

Conventional Color Ink-Jet Ink Set

The above inks R2, Y3, B1 and BK respectively made with red 122, yellow 150, blue 15:3 and black 7 are selected and transferred into a cartridge which is then positioned in an EPSON PRO7500 printer.

The components of ink-jet ink sets in Examples 1-3 and Comparative Examples 1-3 are listed in Table 1.

TABLE 1

| | Inks Used in Color Ink-Jet Ink Sets | | | |
|---|---|---|---|---|
| | Magenta Ink | Cyan Ink | Yellow Ink | Black Ink |
| Example 1 | R1 | B1 | Y1 | BK |
| Example 2 | R1 | B1 | Y2 | BK |
| Example 3 | R1 | B1 | Y3 | BK |
| Comparative | R2 | B1 | Y1 | BK |
| Example 1 | | | | |
| Comparative | R2 | B1 | Y2 | BK |
| Example 2 | | | | |
| Comparative | R2 | B1 | Y3 | BK |
| Example 3 | | | | |

Printing Test

The color ink-jet ink sets in Table 1 are applied to printing seven color blocks including yellow, magenta, cyan, black, red, green, and blue on Double Weight Matte Paper (provided by EPSON Co.) with the EPSON PRO7500 printer. Resolution quality for printing is set at 720 dpi, and color quality is set at ‘photograph’. Performance of these ink sets is evaluated according to lightfastness and color gamuts thereof by means of the following methods.

Lightfastness Test

The printed yellow, magenta, cyan, black, red, green, and blue blocks are chromaticity tested, and then exposed to a Xenon Lamp (ATALAS Co.) at a wavelength of 420 nm. The total light energy is 85 KJ based on AATCC (American Association of Textile Chemists and Colorists) L4. Block discoloration is evaluated according to AATCC by color spectrophotometer (DATACOLOR Co.) detection. The results are listed in Tables 2-4.

Color Gamut

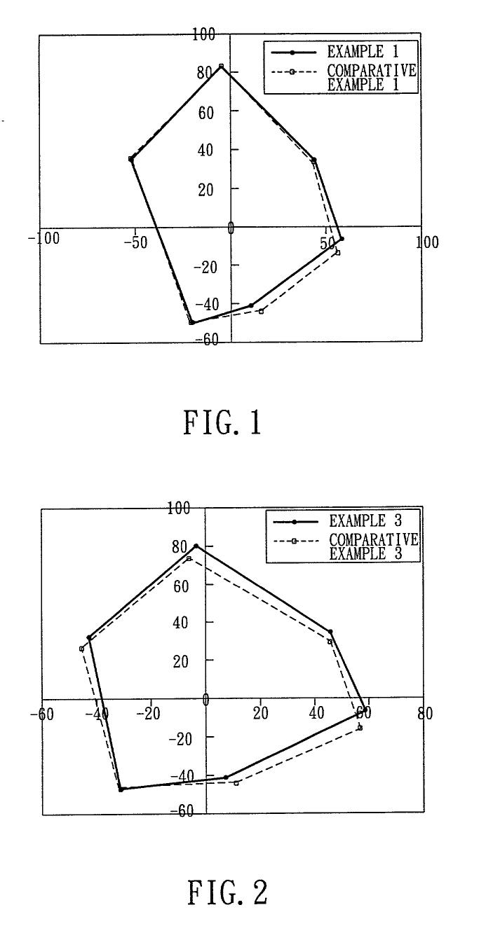

By detecting these yellow, magenta, cyan, red, green, and blue blocks with the color spectrophotometer (DATACOLOR Co.), the chromaticity coordinates (L, a, b) of the six blocks can be read, wherein a and b are listed in Table 5 and then plotted on an X-Y distribution graph to obtain the color gamut's thereof, which are shown in FIG. 1 and FIG. 2.

TABLE 2

| | Example 1/ | Example 2/ | Example 3/ |
|---|---|---|---|
| Chroma- | Comparative | Comparative | Comparative |
| ticity | Example 1 | Example 2 | Example 3 |
| Yellow | 100/100.43 | 100/84.79 | 100/150.48 |
| Magenta | 100/101.99 | 100/94.59 | 100/98.02 |
| Cyan | 100/109.28 | 100/101.41 | 100/99.68 |
| Black | 100/100.29 | 100/97.48 | 100/95.12 |
| Red | 100/94.55 | 100/82.51 | 100/70.54 |
| Green | 100/95.59 | 100/100.22 | 100/131.3 |
| Blue | 100/107.64 | 100/85.76 | 100/102.01 |
| Mixed | 100/99.57 | 100/101.03 | 100/95.85 |
| Black | | | |

TABLE 3

| | Discolo- | Items | | | | | | |
|---|---|---|---|---|---|---|---|---|
| | ration | Yellow | Magenta | Cyan | Black | Red | Green | Blue |
| Example 1 | DEL E | 3.749 | 4.878 | 5.669 | 3.453 | 1.387 | 1.825 | 4.565 |
| | AATCC | 3 | 2-3 | 2-3 | 3 | 4 | 4 | 2-3 |
| Example 2 | DEL E | 3.362 | 3.704 | 4.933 | 3.808 | 3.237 | 2.588 | 7.264 |
| | AATCC | 3 | 3 | 2-3 | 3 | 3 | 3-4 | 2 |
| Example 3 | DEL E | 4.509 | 4.353 | 5.418 | 3.012 | 4.055 | 3.464 | 4.815 |
| | AATCC | 2-3 | 2-3 | 2-3 | 3 | 3 | 3 | 2-3 |
| Comparative | DEL E | 3.407 | 6.024 | 5.326 | 2.86 | 2.107 | 1.247 | 4.645 |
| Example 1 | AATCC | 3 | 2 | 2-3 | 3-4 | 3-4 | 4-5 | 2-3 |
| Comparative | DEL E | 5.704 | 5.934 | 6.278 | 3.604 | 4.283 | 4.56 | 5.06 |
| Example 2 | AATCC | 2-3 | 2 | 2 | 3 | 3 | 3 | 2-3 |
| Comparative | DEL E | 5.21 | 5.324 | 6.278 | 3.604 | 4.283 | 4.56 | 5.06 |
| Example 3 | AATCC | 2-3 | 2-3 | 2 | 3 | 2-3 | 2-3 | 2-3 |

TABLE 4

| | Example 1/ | Example 2/ | Example 3/ |
|---|---|---|---|
| Lightfast | Comparative | Comparative | Comparative |
| -ness | Example 1 | Example 2 | Example 3 |
| Yellow | Similar | Better | — |
| Magenta | Better | Better | Similar |
| Cyan | Worse | Better | Better |
| Black | Worse | Similar | Similar |
| Red | Better | Similar | Better |
| Green | Worse | Better | — |
| Blue | Similar | Worse | Similar |

TABLE 5

| | | | | | Comparative | | Comparative | |
|---|---|---|---|---|---|---|---|---|
| | Example 1 | | Example 3 | | Example 1 | | Example 3 | |
| | a | b | a | b | a | b | a | b |
| Yellow | −5.59 | 84.86 | −2.04 | 76.97 | −5.35 | 84.8 | −5.98 | 69.95 |
| Red | 49.27 | 32.59 | 46.94 | 28.94 | 47.87 | 31.51 | 48.34 | 20.42 |
| Magenta | 60.53 | −9.52 | 60.43 | −10.07 | 58.62 | −20.35 | 58.86 | −20.04 |
| Blue | 7.91 | −41.67 | 8.36 | −41.83 | 13.98 | −44.16 | 13.94 | −44.0 |
| Cyan | −21.87 | −49.88 | −22.97 | −49.51 | −23.28 | 49.55 | −22.75 | −49.67 |
| Green | −50.64 | 36.95 | −46.2 | 32.16 | −50.52 | 39.43 | −51.08 | 25.62 |

Table 2 indicates that the above lightfastness test of these color blocks obtained from Examples and Comparative Examples is performed under equivalent chromaticity. Tables 3 and 4 indicate differences of lightfastness between Examples and Comparative Examples. For magenta, lightfastness of Examples 1 and 2 are better than Comparative Examples 1 and 2, and Example 3 is similar to Comparative Example 3. Therefore, the lightfastness of red 184 can be thought of as better than the lightfastness of red 122.

FIG. 1 shows that the color gamut of Example 1 is similar to the color gamut of Comparative Example 1, and FIG. 2 shows that the color gamut of Example 3 is smaller than the color gamut of Comparative Example 3. In other words, red 184 can generate similar color gamuts as red 122 when arranged with different yellows in a cartridge.

In the present invention, red 184 is used in ink-jet ink sets, providing an option to conventional ink sets while performing with good lightfastness and producing similar color gamuts.

From the foregoing description, one skilled in the art can easily ascertain the essential characteristics of this invention, and without departing from the scope thereof, can make various changes and modifications of the invention to adapt it to various usages and conditions. Thus, other embodiments are also within the claims.

What is claimed is:

1. A magenta ink for ink-jet printing, comprising red 184 and a carrier.

2. The magenta ink as claimed in claim 1, wherein said red 184 has a concentration ranging between 0.1 wt. % and 5.0 wt. %.

3. The magenta ink as claimed in claim 1, wherein said carrier comprises:
(i) at least a low vapor-pressure solvent;
(ii) at least a surfactant; and
(iii) water.

4. The magenta ink as claimed in claim 3, wherein said low vapor-pressure solvent is selected from a group consisting of glycols, diols, homologous diols, glycol esters, mono and di glycol ethers, long chain alcohols, esters, ketones, lactones, and lactams, or mixtures thereof.

5. The magenta ink as claimed in claim 3, wherein said low vapor-pressure solvent has a concentration ranging between 0 wt. % and 20 wt. %.

6. The magenta ink as claimed in claim 3, wherein said surfactant is a nonionic surfactant.

7. The magenta ink as claimed in claim 3, wherein said surfactant has a concentration ranging between 0.1 wt. % and 1.0 wt. %.

8. A color ink set for ink-jet printing, comprising:
(a) a magenta ink comprising red 184 and a carrier;
(b) a yellow ink; and
(c) a cyan ink.

9. The color ink set as claimed in claim 8, wherein said yellow ink comprises yellow pigment and a carrier, and said yellow pigment is selected from a group consisting of yellow 155, yellow 150, and yellow 74, or mixtures thereof.

10. The color ink set as claimed in claim 8, wherein said cyan ink comprises cyan pigment and a carrier, and said cyan pigment is selected from a group consisting of blue 15:3, and blue 60, or mixtures thereof.

11. The color ink set as claimed in claim 8, further comprising (d) a black ink containing black 7 and a carrier.

12. The color ink set as claimed in any one of claim 8 to claim 11, wherein said carrier comprises:
(i) at least a low vapor-pressure solvent;
(ii) at least a surfactant; and
(iii) water.

13. The color ink set as claimed in claim 8, wherein said red 184 in said magenta ink has a concentration ranging between 0.1 wt. % and 5.0 wt. %.

14. The color ink set as claimed in claim 9, wherein said yellow pigment in said yellow ink has a concentration ranging between 0.1 wt. % and 5.0 wt. %.

15. The color ink set as claimed in claim 10, wherein said cyan pigment in said cyan ink has a concentration ranging between 0.1 wt. % and 5.0 wt. %.

16. The color ink set as claimed in claim 11, wherein said pigment black 7 in said black ink has a concentration ranging between 0.1 wt. % and 5.0 wt. %.

17. The color ink set as claimed in claim 12, wherein said carrier further comprises (iv) at least an additive.

18. The color ink set as claimed in claim 17, wherein said additive is a microbial reagent, and said microbial has a concentration ranging between 0.1 wt. % and 0.5 wt. %.

19. The color ink set as claimed in claim 12, wherein said low vapor-pressure solvent is selected from a group consisting of glycols, diols, homologous diols, glycol esters, mono and di glycol ethers, long chain alcohols, esters, ketones, lactones, and lactams, or mixtures thereof.

20. The color ink set as claimed in claim 19, wherein said lactam is 2-pyrrolyl ketone.

21. The color ink set as claimed in claim 19, wherein said glycol is diethylene glycol.

22. The color ink set as claimed in claim 12, wherein said low vapor-pressure solvent has a concentration ranging between 0 wt. % and 20 wt. %.

23. The color ink set as claimed in claim 12, wherein said surfactant is a nonionic surfactant.

24. The color ink set as claimed in claim 12, wherein said surfactant has a concentration ranging between 0.1 wt. % and 1.0 wt. %.
